(19) United States
(12) Patent Application Publication
(10) Pub. No.: US 2019/0162693 A1
(43) Pub. Date: May 30, 2019

(54) SENSOR ELEMENT AND GAS SENSOR INCLUDING THE SAME

(71) Applicant: NGK Spark Plug Co., LTD., Nagoya (JP)

(72) Inventors: Ai IGARASHI, Konan (JP); Takuya NAKATSUKASA, Komaki (JP)

(73) Assignee: NGK Spark Plug Co., LTD., Nagoya (JP)

(21) Appl. No.: 16/166,907

(22) Filed: Oct. 22, 2018

(30) Foreign Application Priority Data
Nov. 27, 2017 (JP) 2017-226507

(51) Int. Cl. G01N 27/409; H05B 3/03; H05B 3/18; H05B 3/20; H05B 3/48; H05B 3/74

(52) U.S. Cl. CPC G01N 27/409; H05B 3/03; H05B 3/74; H05B 3/20; H05B 3/48; H05B 3/18

(57) ABSTRACT

A sensor element comprises a plate-shaped portions including a first portion, a second portion, and a third portion all of which extend in a direction of an axial line and are stacked in a stacking direction intersecting the direction of the axial line. In a cross section of the sensor element, which cross section includes a heat generating portion and is perpendicular to the direction of the axial line, pair of inner linear portions are disposed so as not to overlap a reference gas introduction hole in the stacking direction, and wherein a relation L3<L4 is satisfied, where L3 is the length between each of the outer linear portions and an adjacent one of the inner linear portions, and L4 is the length between the pair of inner linear portions adjacent to each other.

This application claims the benefit of Japanese Patent Application No. 2017-226507, filed Nov. 27, 2017, which is incorporated herein by reference in its entirety.

### FIELD OF THE INVENTION

The present invention relates to a sensor element preferably used to detect the concentration of a specific gas contained in combustion gas or exhaust gas from, for example, a combustor or an internal combustion engine and to a gas sensor including the sensor element.

### BACKGROUND OF THE INVENTION

A gas sensor for detecting the concentration of a specific component (such as oxygen) in exhaust gas from an internal combustion engine has been used. This gas sensor includes a sensor element disposed therein. One known sensor element structure is a stack of a plurality of plate-shaped ceramic layers and includes a sensor section including a solid electrolyte body and a pair of electrodes disposed on the solid electrolyte body, and one of the electrodes is exposed to an air introduction hole (reference gas introduction hole) formed in the element (see Japanese Unexamined Publication No. 2007-42615 (FIGS. 9 and 10)).

The sensor element further includes a heater, and the sensor section is activated by heat generated by the heater.

### Problem to be Solved by the Invention

In the structure in Japanese Unexamined Publication No. 2007-42615, maximum heat generation portions of the heater are located directly below the reference gas introduction hole. In this case, when the heat of the heater transfers from the maximum heat generation portions of the heater to the sensor section, the reference gas present in the heat transfer path serves as a heat insulating layer. This impedes heat transfer from the heater to the sensor section, and a large temperature gradient is generated in the sensor section. When the temperature gradient in the sensor section is large, cracking may occur in the sensor element after repeated thermal cycles, thereby deteriorating the voltage withstanding performance of the sensor element.

Accordingly, it is an object of the present invention to provide a sensor element having a reference gas introduction hole and having improved voltage withstanding performance and to provide a gas sensor including the sensor element.

### SUMMARY OF THE INVENTION

### Means for Solving the Problem

In order to solve the above-described problem, the present invention provides a sensor element comprising plate-shaped portions that include a first portion, a second portion, and a third portion. The plate-shaped portions extend in a direction of an axial line and are stacked in a stacking direction intersecting the direction of the axial line. The first portion includes a solid electrolyte body, a reference gas-side electrode and a measurement gas-side electrode which is disposed on surfaces of the solid electrolyte body. The second portion has a reference gas introduction hole to which the reference gas-side electrode is exposed and which is open toward a rear end side in the direction of the axial line. The third portion includes a heat generating portion and a pair of lead portions. The heat generating portion includes a pair of outer linear portions, a pair of inner linear portions disposed between the outer linear portions, first connection portions each of which connects together forward ends of the outer linear portion and the inner linear portion located adjacent to each other, and a second connection portion which connects together rear ends of the pair of inner linear portions. The pair of lead portions are connected to rear ends of the respective outer linear portions. In a cross section of the sensor element, which cross section includes the heat generating portion and is perpendicular to the direction of the axial line, the pair of inner linear portions are disposed so as not to overlap the reference gas introduction hole in the stacking direction, and a relation L3<L4 is satisfied, where L3 is the length between each of the outer linear portions and an adjacent one of the inner linear portions, and L4 is the length between the pair of inner linear portions adjacent to each other.

In this sensor element, the pair of inner linear portions are disposed so as not to overlap the reference gas introduction hole in the stacking direction. Therefore, maximum heat generation portions located between the outer linear portions and their adjacent inner linear portions are also disposed so as not to overlap the reference gas introduction hole in the stacking direction.

Therefore, the heat of the third portion can easily transfer from the maximum heat generation portions of the third portion to the first portion because the reference gas introduction hole of the second portion is not present in the heat transfer path, so that the temperature gradient in the first portion is small. Therefore, the voltage withstanding performance of the sensor element is improved.

In the sensor element of the present invention, in a cross section of the sensor element, which cross section is taken in the stacking direction intersecting the direction of the axial line, a relation 0.2×L1≤L2 is preferably satisfied, where L1 is the length of the sensor element in a width direction, and L2 is the length of the reference gas introduction hole in the width direction.

In this sensor element, the ratio of occupation of the reference gas introduction hole in the width direction of the sensor element tends to be large, and therefore the invention is more effective.

The sensor element of the present invention is preferably a limiting current sensor element.

In the limiting current sensor element, the reference gas introduction hole tends to be large, and therefore the invention is more effective.

A gas sensor of the present invention comprises a plate-shaped sensor element, and a metallic shell that holds the sensor element, wherein the sensor element of the present invention is used.

In this gas sensor, the voltage withstanding performance of the sensor element is improved, and therefore the reliability of the gas sensor is improved.

### Effects of the Invention

According to the present invention, the voltage withstanding performance of the sensor element having the reference gas introduction hole can be improved.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a cross-sectional view of an example of a gas sensor (oxygen sensor) including a sensor element according to an embodiment of the present invention, the cross-section being taken in an axial direction.

FIG. 2 is a schematic exploded perspective view of the sensor element.

FIG. 3 is a schematic cross-sectional view of the sensor element, the cross section being perpendicular to the direction of a central axis O.

FIG. 4 is a projection view obtained by projecting a heating element 141 onto a second layer 140b.

FIG. 5 is a projection view obtained by projecting a reference gas introduction chamber 131 onto the second layer 140b and the heating element 141.

FIG. 6 is a table showing the dimensions of a heat generating portion and lead portions in a heater layer.

### DETAILED DESCRIPTION OF THE INVENTION

An embodiment of the present invention will be described.

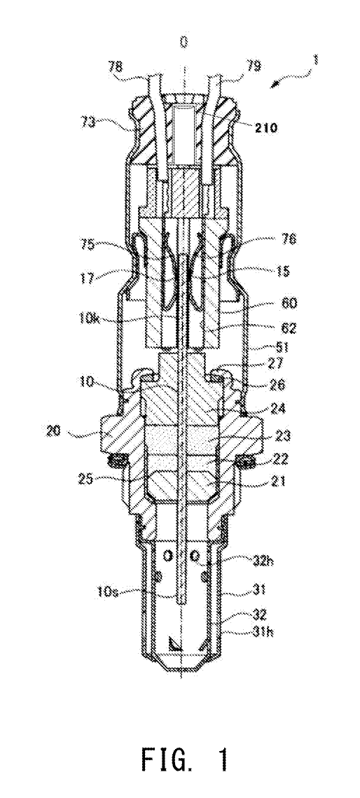

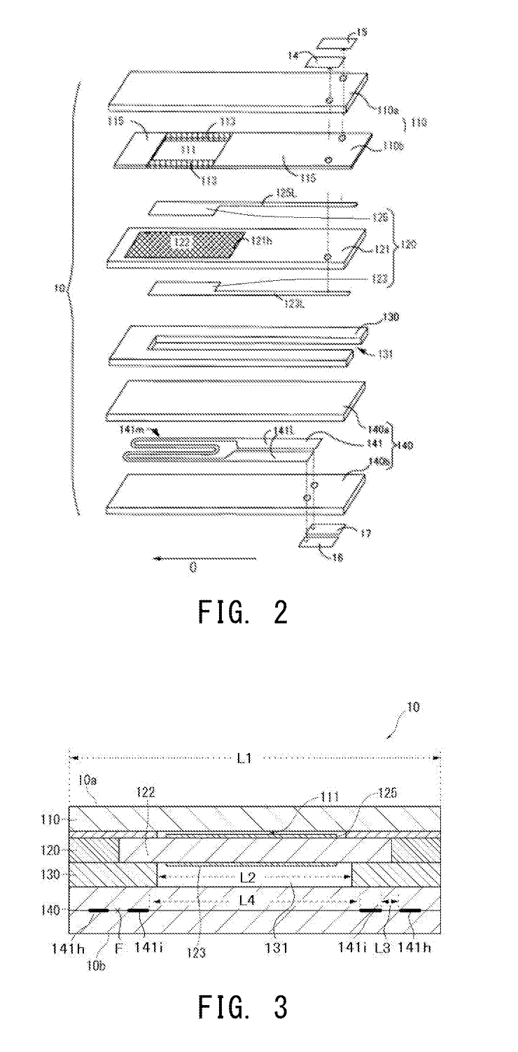

FIG. 1 is a cross-sectional view of an example of a gas sensor (oxygen sensor) 1 including a sensor element according to an embodiment of the present invention, the cross-section being taken in the direction of a central axis O. FIG. 2 is a schematic exploded perspective view of the sensor element 10, and FIG. 3 is a cross-sectional view of the sensor element 10, the cross section being perpendicular to the direction of the central axis O.

The gas sensor 1 includes, as main components, the sensor element 10 and a metallic shell 20. The sensor element 10 is an elongated plate-shaped element and includes a sensor cell for measuring the concentration of oxygen in exhaust gas, which is a measurement gas. The sensor element 10 includes a forward end portion 10s in which the sensor cell is disposed and a rear end portion 10k on which sensor-side electrode pads 14 and 15 (only the pad 15 is shown) electrically connected to lead wires 78 and 79 are disposed. The sensor element 10 is held by the metallic shell 20 with the forward end portion 10s protruding from the forward end of the metallic shell 20 and the rear end portion 10k protruding from the rear end of the metallic shell 20.

The metallic shell 20 has a tubular shape for holding the sensor element 10 therein. A metallic tubular outer protector 31 and a metallic tubular inner protector 32 are disposed at the forward end of the metallic shell 20 and cover the forward end portion 10s of the sensor element 10. The outer protector 31 has a plurality of gas introduction holes 31h, and the inner protector 32 has a plurality of gas introduction holes 32h. The measurement gas is introduced through the gas introduction holes 31h and 32h into a space around the forward end portion 10s of the sensor element 10.

An annular ceramic holder 21, powder filler layers (hereinafter may be referred to also as talc rings) 22 and 23, and a ceramic sleeve 24 are disposed in this order from the forward end side within the metallic shell 20 so as to surround the outer circumference of the sensor element 10. A metallic holder 25 is disposed around the outer circumference of the ceramic holder 21 and the outer circumference of the talc ring 22, and a crimp packing 26 is disposed at the rear end of the ceramic sleeve 24. A rear end portion 27 of the metallic shell 20 is crimped such that the ceramic sleeve 24 is pressed toward the forward end side through the crimp packing 26.

A cylindrical outer tube 51 is disposed at the rear end of the metallic shell 20 so as to surround the rear end portion 10k of the sensor element 10. A separator 60 is disposed inside the outer tube 51. The separator 60 surrounds the rear end portion 10k of the sensor element 10 and holds four lead wires 78 and 79 (only two of them are shown in FIG. 1) such that they are spaced apart from one another.

The separator 60 has an insertion hole 62 extending therethrough in the direction of the central axis O, and the rear end portion 10k of the sensor element 10 is inserted into the insertion hole 62. Four terminal members 75 and 76 are disposed within the insertion hole 62 so as to be spaced apart from one another. The four terminal members 75 and 76 are electrically connected, respectively, to the sensor-side electrode pads 14 and 15 of the sensor element 10 and two heater-side electrode pads 16 and 17 (only the heater-side electrode pad 17 is shown) of the sensor element 10.

A grommet 73 that seals a rear end opening of the outer tube 51 is fitted into the rear end of the outer tube 51, and the four lead wires 78 and 79 extend through insertion holes of the grommet 73 to the outside. A filter 210 is disposed in a central portion of the grommet 73. The filter 210 allows reference gas to be introduced from the outside into the rear end portion 10k of the sensor element 10 and prevents entry of water.

Referring next to FIGS. 2 and 3, the structure of the sensor element 10 will be described.

The sensor element 10 includes a first ceramic layer 110, a second ceramic layer 120, a third ceramic layer 130, and a heater layer 140 that are sequentially stacked in a thickness direction (stacking direction) from top to bottom in FIG. 2. These layers 110 to 140 are formed of an insulating ceramic such as alumina and have rectangular plate shapes having the same outside dimensions (at least width and length).

The first ceramic layer 110 is formed by stacking a protective layer 110a and a measurement chamber layer 110b, and a rectangular measurement chamber 111 is formed in a forward end portion (a left portion in FIG. 2) of the measurement chamber layer 110b. Porous diffusive layers 113 for separating the measurement chamber 111 from the outside are disposed along opposite long sides of the measurement chamber layer 110b. Ceramic insulating layers 115 for forming sidewalls of the measurement chamber 111 are disposed on the forward and rearward end sides of the measurement chamber 111.

The measurement chamber 111 is in communication with the outside through the porous diffusive layers 113, and the porous diffusive layers 113 allow gas diffusion between the outside and the measurement chamber 111 under prescribed rate-determining conditions. The sensor element 10 thereby serves as a limiting current sensor element. The porous diffusive layers 113 form opposite longitudinal sidewalls that extend in the lengthwise direction (the direction of the central axis O) of the sensor element 10 and are exposed to the outside.

The second ceramic layer 120 includes an alumina-made insulating cell layer 121 including a rectangular plate-shaped solid electrolyte body 122; a reference gas-side electrode 123 disposed on the back side of the solid electrolyte body 122; and a measurement gas-side electrode 125 disposed on the front side of the solid electrolyte body 122. A rectangular through opening 121h is provided in a forward end portion (a left portion in FIG. 2) of the cell layer 121, and the solid electrolyte body 122 is fitted in the through opening 121h. Lead portions 123L and 125L extend rearward from the reference gas-side electrode 123 and the measurement gas-side electrode 125, respectively.

The solid electrolyte body 122, the reference gas-side electrode 123, and the measurement gas-side electrode 125 form a cell for detecting the concentration of oxygen in the measurement gas. The measurement gas-side electrode 125 is exposed to the measurement chamber 111, and the reference gas-side electrode 123 is exposed to a reference gas introduction chamber 131 described later.

In the present embodiment, the solid electrolyte body 122 is fitted in the through opening 121h of the cell layer 121, but this is not a limitation. The cell layer 121 itself may be a solid electrolyte body.

The lead portion 123L is electrically connected to the sensor-side electrode pad 14 through a conductor disposed in through holes provided in the cell layer 121, the measurement chamber layer 110b, and the protective layer 110a. The lead portion 125L is electrically connected to the sensor-side electrode pad 15 through a conductor disposed in through holes provided in the measurement chamber layer 110b and the protective layer 110a.

Detection signals from the reference gas-side electrode 123 and the measurement gas-side electrode 125 are outputted to the outside from the sensor-side electrode pads 14 and 15 through the two lead wires 79, and the oxygen concentration is thereby detected.

The third ceramic layer 130 is formed as a frame having a squarish U-shape in plan view with the reference gas introduction chamber 131 extending from the forward end side (the left side in FIG. 2) toward the rear end side. Therefore, the reference gas introduction chamber 131 has an opening on an surface of the third ceramic layer 130 on the rear end side (the surface on the right side in FIG. 2) so that the reference gas introduction chamber 131 is in communication with the outside.

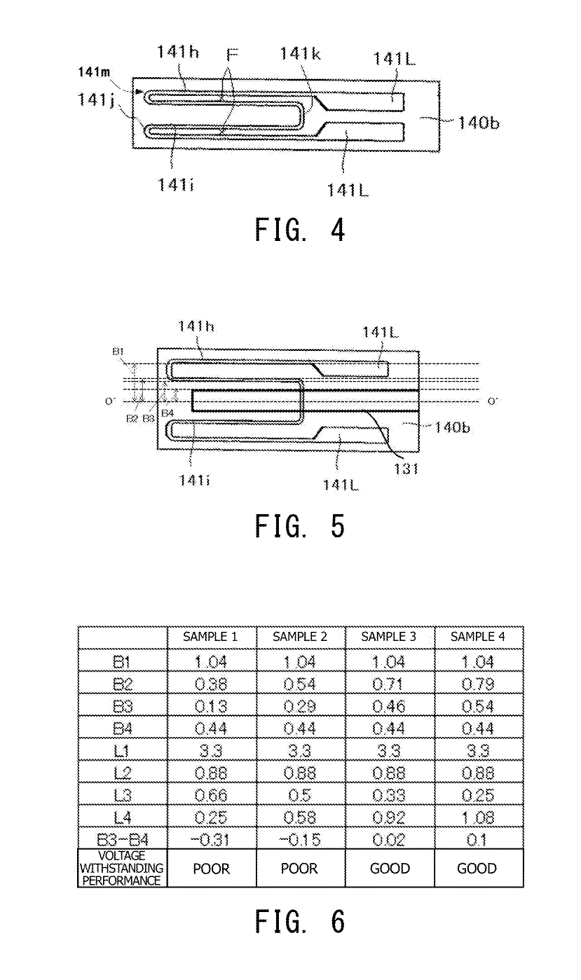

The heater layer 140 includes a first layer 140a, a second layer 140b, and a heating element 141 disposed between the first layer 140a and the second layer 140b. The first layer 140a faces the third ceramic layer 130. As shown in FIG. 4, the heating element 141 includes a heat generating portion 141m having a meandering pattern, and a pair of lead portions 141L. The heat generating portion 141m includes a pair of outer linear portions 141h extending in the direction of the central axis O; a pair of inner linear portions 141i disposed between the outer linear portions 141h and extending in the direction of the central axis O; two first connection portions 141j each of which connects together forward ends of an outer linear portion 141h and an inner linear portion 141i located adjacent to each other; and a second connection portion 141k which connects together rear ends of the pair of inner linear portions 141i. The pair of lead portions 141L are connected to rear ends of the pair of the outer linear portions 141h.

The lead portions 141L are electrically connected to heater-side electrode pads 16 and 17 through conductors disposed in through holes provided in the second layer 140b. When the heating element 141 is energized through the two lead wires 78 and the heater-side electrode pads 16 and 17, the heating element 141 generates heat, and the solid electrolyte body 122 is thereby activated.

The above linear portions are not limited to straight portions extending parallel to the direction of the central axis O, so long as at least 50% of them extend linearly in the direction of the central axis O. The linear portions may include cranked portions.

The solid electrolyte body 122 is formed, for example, from a partially stabilized zirconia sintered body prepared by adding yttria (Y₂O₃) or calcia (CaO) serving as a stabilizer to zirconia (ZrO₂).

The reference gas-side electrode 123, the measurement gas-side electrode 125, the heating element 141, the sensor-side electrode pads 14 and 15, and the heater-side electrode pads 16 and 17 may be formed from a platinum group element. Preferred examples of the platinum group element forming these components include Pt, Rh, and Pd. One of these elements may be used alone, or a combination of two or more may be used.

The second ceramic layer 120 corresponds to the “first portion” in the claims. The third ceramic layer 130 and the heater layer 140 correspond to the “second portion” and the “third portion,” respectively, in the claims.

The reference gas introduction chamber 131 corresponds to the “reference gas introduction hole” in the claims.

As shown in FIG. 3, in a cross section containing the heat generating portion 141m and perpendicular to the direction of the central axis O, the pair of inner linear portions 141i are disposed so as not to overlap the reference gas introduction chamber 131 in the stacking direction. Let the length between each of the outer linear portions 141h and an adjacent one of the inner linear portions 141i be L3, and the length between the pair of inner linear portions 141i adjacent to each other be L4. Then the relation L3<L4 holds.

Specifically, when the above relation holds, each of maximum heat generation portions F is located between an outer linear portion 141h and an inner linear portion 141i located adjacent to each other. The maximum heat generation portions F are also disposed so as not to overlap the reference gas introduction chamber 131 in the stacking direction.

In this case, the heat of the heater layer 140 can easily transfer from the maximum heat generation portions F to the second ceramic layer 120 because the reference gas introduction chamber 131 of the third ceramic layer 130 is not present in the heat transfer path, so that the temperature gradient in the second ceramic layer 120 is small. Therefore, the occurrence of cracking in the sensor element 10 can be prevented, and the voltage withstanding performance of the sensor element 10 is improved.

Let the maximum length of the sensor element 10 in the width direction be L1, and the maximum length of the reference gas introduction chamber 131 in the width direction be L2. Then it is preferable that the relation 0.2×L1≤L2 holds.

In this sensor element 10, since the ratio of occupation of the reference gas introduction chamber 131 in the width direction of the sensor element 10 tends to be large, the present invention is more effective.

In the above embodiment, the present invention is applied to the oxygen sensor (oxygen sensor element). However, the present invention is not limited to the above embodiment and is applicable to any gas sensor (sensor element) having a reference gas introduction hole. It will be appreciated that the present invention is not limited to these applications and encompasses various modifications and equivalents within the spirit and scope of the present invention. The present invention may be applied to, for example, NOx sensors (NOx sensor elements) that detect the concentration of NOx in measurement gas and to HC sensors (HC sensor elements) that detect the concentration of HC. Specifically, the present invention may be applied to any sensor including a first portion having the sensing function, a second portion having a reference gas introduction hole, and a third portion for heating the sensor that are stacked in this order from the top to bottom.

Each of the first portion 120, the second portion 130, and the third portion 140 may be a single layer or a stack of a plurality of layers.

### EXAMPLES

The present invention will be described in more detail by way of Examples. However, the present invention is not limited these Examples.

Samples 1 to 4 of the sensor element 10 shown in FIGS. 2 and 3 were produced. Samples 1 to 4 differ in the positions of the inner linear portions 141i of the third portion 140. In all the samples, the length L1 of the sensor element 10 in the width direction is 3.3 mm, and the width L2 of the reference gas introduction chamber 131 (the length of the reference gas introduction chamber 131 in the width direction of the sensor element 10) is 0.88 mm. Specifically, L2/L1≈0.27, and the relation 0.2×L1≤L2 holds.

FIG. 5 is a projection view obtained by projecting the reference gas introduction chamber 131 onto the second layer 140b and the heating element 141 in the third portion 140. As shown in FIG. 5, the length from the central axis O′-O′ of the third portion 140 to the inner edge of each outer linear portion 141h is denoted by B1, and the length from the central axis O′-O′ to the outer edge of each inner linear portion 141i is denoted by B2. The length from the central axis O′-O′ to the inner edge of each inner linear portion 141i is denoted by B3, and the length from the central axis O′-O′ to a side surface of the reference gas introduction chamber 131 is denoted by B4. The lengths B1 to B4 and L1 to L4 are listed in FIG. 6. In FIG. 6, the unit of length (mm) is omitted. The heating element 141 and the reference gas introduction chamber 131 shown in FIG. 5 are prepared so as to be line-symmetric with respect to the central axis O′-O′.

Samples 1 to 4 were subjected to a withstand voltage test to evaluate their voltage withstanding performance. The evaluation results are shown in FIG. 6. In the withstand voltage test, a prescribed voltage (12 V) was applied to the heating element until the temperature of the outer surface of the sensor element reached a prescribed temperature (830° C.) After the temperature had reached the prescribed temperature, the application of the voltage was stopped to cool the sensor element to room temperature. This series of processes is defined as one cycle, and this cycle was repeated 10 times. Then, when no cracking was found in the sensor element, the above processes were repeated with the applied voltage increased. The higher the voltage at which cracking occurs in the sensor element, the better the voltage withstanding performance. In the withstand voltage test, the applied voltage causing cracking in sample 2 was used as a reference voltage. When cracking occurred in a sensor element at a voltage equal to or lower than the reference voltage, the sensor element was rated “POOR.” When no cracking occurred in a sensor element at the reference voltage, the sensor element was rated “GOOD.”

As shown in FIG. 6, in samples 1 and 2, the length B3 from the central axis O′-O′ to the inner edge of each inner linear portion 141i is shorter than the length B4 from the central axis O′-O′ to a side surface of the reference gas introduction chamber 131. This means that the inner linear portions 141i are placed so as to partially overlap the reference gas introduction chamber 131 in the stacking direction. In samples 3 and 4, the length B3 from the central axis O′-O′ to the inner edge of each inner linear portion 141i is longer than the length B4 from the central axis O′-O′ to a side surface of the reference gas introduction chamber 131. This means that the inner linear portions 141i are disposed so as not to overlap the reference gas introduction chamber 131 in the stacking direction.

In sample 1, the relation L3>L4 holds. In samples 2 to 4, the relation L3<L4 holds.

As can be seen in the results of the withstand voltage test, cracking occurred in sample 1 at a lower applied voltage than in sample 2. In samples 3 and 4, no cracking occurred at the applied voltage at which cracking occurred in sample 2. This may be because of the following reason. The inner linear portions 141i are disposed so as not to overlap the reference gas introduction chamber 131 in the stacking direction. In this case, the heat of the heater layer 140 can easily transfer from the maximum heat generation portions F to the second ceramic layer 120 because the reference gas introduction chamber 131 of the third ceramic layer 130 is not present in the heat transfer path, so that the temperature gradient in the second ceramic layer 120 is small. As can be seen from the above results, when the inner linear portions 141i are disposed so as not to overlap the reference gas introduction chamber 131 in the stacking direction, the voltage withstanding performance of the sensor element 10 is improved.

### DESCRIPTION OF REFERENCE NUMERALS

1 gas sensor
10 sensor element
20 metallic shell
110 first ceramic layer
120 second ceramic layer
130 third ceramic layer
131 reference gas introduction chamber
140 heater layer
O, O′ central axis
F maximum heat generation portion

1. A sensor element comprising:
plate-shaped portions that include a first portion, a second portion, and a third portion, wherein
the plate-shaped portions extend in a direction of an axial line and are stacked in a stacking direction intersecting the direction of the axial line, the first portion includes a solid electrolyte body, a reference gas-side electrode and a measurement gas-side electrode which is disposed on surfaces of the solid electrolyte body,
the second portion has a reference gas introduction hole to which the reference gas-side electrode is exposed and which is open toward a rear end side in the direction of the axial line,
the third portion includes a heat generating portion and a pair of lead portions, the heat generating portion including a pair of outer linear portions, a pair of inner linear portions disposed between the outer linear portions, first connection portions each of which connects together forward ends of the outer linear portion and the inner linear portion located adjacent to each other, and a second connection portion which connects together rear ends of the pair of inner linear portions, the pair of lead portions being connected to rear ends of the respective outer linear portions,
in a cross section of the sensor element, which cross section includes the heat generating portion and is perpendicular to the direction of the axial line, the pair of inner linear portions are disposed so as not to overlap the reference gas introduction hole in the stacking direction, and
a relation L3<L4 is satisfied, where L3 is a length between each of the outer linear portions and an adjacent one of the inner linear portions, and L4 is a length between the pair of inner linear portions adjacent to each other.

2. The sensor element according to claim 1, wherein, in a cross section of the sensor element, which cross section is taken in the stacking direction intersecting the direction of the axial line, a relation 0.2×L1≤L2 is satisfied, where L1 is a length of the sensor element in a width direction, and L2 is a length of the reference gas introduction hole in the width direction.

3. The sensor element according to claim 1, wherein the sensor element is a limiting current sensor element.

4. A gas sensor comprising:
a plate-shaped sensor element; and
a metallic shell that holds the sensor element, wherein
the sensor element according to claim 1 is used.
